(19) United States
(12) Patent Application Publication
(10) Pub. No.: US 2013/0104516 A1
(43) Pub. Date: May 2, 2013

(54) METHOD OF MONITORING AN OPERATION OF A COMPRESSOR BLEED VALVE

(71) Applicants: Gerardo Fidel Varillas, Greenville, SC (US); John Edward Pritchard, Simpsonville, SC (US)

(72) Inventors: Gerardo Fidel Varillas, Greenville, SC (US); John Edward Pritchard, Simpsonville, SC (US)

(73) Assignee: GENERAL ELECTRIC COMPANY, Schenectady, NY (US)

(21) Appl. No.: 13/285,486

(22) Filed: Oct. 31, 2011

(51) Int. Cl. F02C 9/00

(52) U.S. Cl. 60/39.24; 60/772

(57) ABSTRACT

A method, apparatus and gas turbine for monitoring an operation of a valve of a gas turbine is disclosed. A first sensor obtains a first indicator of a configuration of the valve of the gas turbine. A second sensor measures a physical parameter affected by the valve configuration. A processor is used to obtain a second indicator of the valve configuration from the measured physical parameter and compare the first indicator to the second indicator to monitor the operation of the valve.

### BACKGROUND OF THE INVENTION

The subject matter disclosed herein relates to a method of monitoring an operation of a compressor bleed valve of a gas turbine generator. Gas turbine generators typically have one or more compressor bleed valves that are generally opened during start-up and shut-down operations and are otherwise closed. A compressor bleed valve that is closed during a start-up or shut-down operation can cause damage the gas turbine generator. Thus, configuration sensors are typically coupled to the bleed valves to provide an indication of whether the valve are opened or closed. However, due to the turbine stresses and temperatures, these configuration sensors can fail or give faulty indicators regarding the valves' configurations. Therefore, the present disclosure provides a method of monitoring a compressor bleed valve using a physical parameter.

### BRIEF DESCRIPTION OF THE INVENTION

According to one aspect of the invention, a method of monitoring a valve of a gas turbine is disclosed that includes obtaining a first indicator of a configuration of the valve using a configuration sensor coupled to the valve; measuring a physical parameter affected by the valve configuration; obtaining a second indicator of the valve configuration from the measured physical parameter; and comparing the first indicator and the second indicator to monitor the valve.

According to another aspect of the invention, an apparatus for monitoring a valve of a gas turbine is disclosed. The apparatus includes a first sensor configured to obtain a first indicator of a configuration of the valve; a second sensor configured to measure a physical parameter affected by the valve configuration; and a processor configured to obtain a second indicator of the valve configuration from the measured physical parameter, and compare the first indicator to the second indicator to monitor the valve.

According to yet another aspect of the invention, a gas turbine is disclosed. The gas turbine includes a compressor stage; a valve configured to control bleeding of air from the compressor stage; a first sensor configured to obtain a first indicator of a configuration of the valve; a second sensor configured to measure a physical parameter affected by the valve configuration; and a processor configured to: obtain a second indicator of the valve configuration from the measured physical parameter, and compare the first indicator to the second indicator to monitor the valve.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows an exemplary gas turbine generator in one embodiment of the present disclosure;

FIG. 2 is an illustration of an exemplary compressor bleed valve system of the present disclosure;

FIG. 3 shows a monitoring system for monitoring the bleed valves of the gas turbine generator of FIG. 1 in an exemplary embodiment of the present disclosure; and

FIG. 4 is a flow chart of an exemplary method of the present disclosure for monitoring a valve.

The detailed description explains embodiments of the invention, together with advantages and features, by way of example with reference to the drawings.

### DETAILED DESCRIPTION OF THE INVENTION

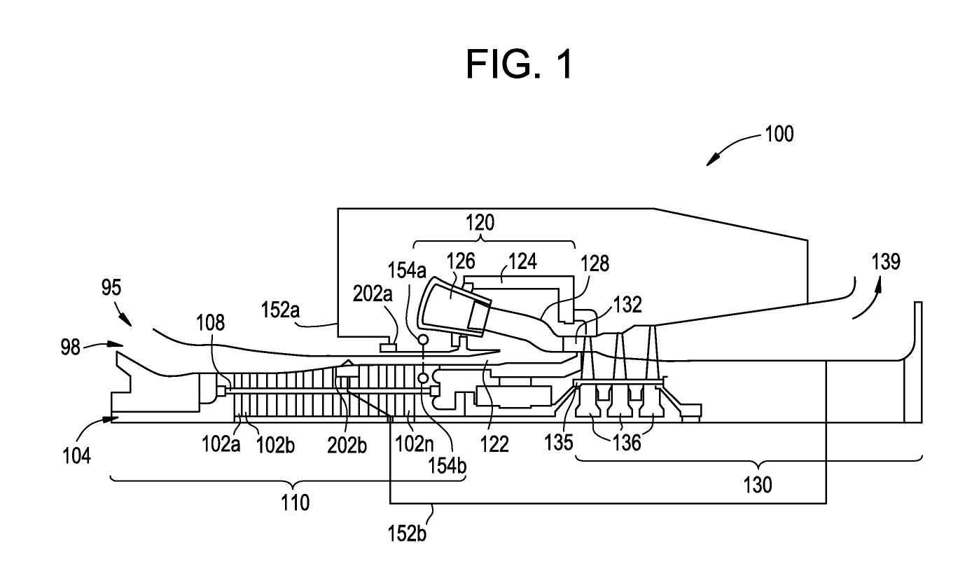

FIG. 1 shows an exemplary gas turbine generator 100 in one embodiment of the present disclosure. The exemplary gas turbine generator is typically used in a power plant. Generally, the gas turbine generator 100 includes a compressor section 110, a combustion section 120 and a turbine section 130. The compressor section 110 includes a plurality of compressor stages 102a . . . 102n for compressing air. An exemplary compressor stage includes stationary vanes supported by an outer housing 104 of the compressor section 110 and rotating blades which are mounted on a common shaft 108. Ambient air 95 is introduced through inlet 98 and successively compressed at each compressor stage by rotation of the blades. After being compressed at the final compression stage (102n), the compressed air travels through an annular diffuser 122 to a compressed air chamber 124 which surrounds a combustion chamber 126 and transition member 128 of the combustion section 120. Fuel is mixed with the compressed air in the combustion chamber 126 and the air/fuel mixture is burned in the combustion chamber 126 to create a working gas which is directed through the transition member 128 to a turbine nozzle 132 to the turbine section 130. The turbine section 130 is made up of a serial arrangement of stages, each stage having rotating blades 136. The rotating blades are supported by a common rotor system 135. The working gas exiting the transition member 128 expands through the serial stages to cause rotation of the blades. The rotation of the blades in turn imparts rotation to the rotor system 135. In one aspect, the turbine rotor system 135 can be connected to the compressor shaft 108 so that rotation of the turbine rotor system 135 drives the blades of the compressor section 110. In power plant applications, the rotor system 135 is generally coupled to a rotor of an electrical generator (not shown) to drive the generator to create electricity. The working gas ultimately is exhausted at the exhaust 139 of the turbine section 130 and can be directed through an exhaust stack to the ambient atmosphere, to a cooling unit or to a heat exchanger.

The generator 100 also includes one or more conduits 152a and 152b providing airflow from the compressor section 110 to a turbine exhaust 139 of the turbine section 130. Bleed valves 202a and 202b couple conduits 152a and 152b, respectively, to the compressor section and are configured to control airflow through the conduits. In a first configuration, a bleed valve is opened to allow air from the compressor to bleed into its associated air conduit. In a second configuration, the bleed valve is closed to prevent air from flowing into its associated air conduit 152a. Configurations of the bleed valves are generally set based on a mode of operation of the gas turbine generator 100. For example, in a typical steady-state mode of operation, the bleed valves are closed so that air entering the compressor section 100 at inlet 95 is sent entirely to the combustion section 120. For start-up and shut-down modes, the bleed valves are typically opened to allow airflow through the conduits.

FIG. 1 further shows parameter sensors 154a and 154b located at or near a compressor discharge of the compressor section 110. The parameter sensors are configured to measure a physical parameter that is affected by the configuration of the bleed valves 202a and 202b. In an exemplary embodiment, the physical parameter is a compressor discharge pressure (i.e., pressure of gas exiting the compressor section) and the parameter sensors 154a and 154b are pressure sensors for measuring the compressor discharge pressure. In general, compressor discharge pressure measurements obtained at parameter sensor 154a are affected by the configuration of bleed valve 202a, and compressor discharge pressure measurements obtained at parameter sensor 154b are affected by the configuration of bleed valve 202b. The parameter sensors are configured to provide the measure parameters to a monitoring device, such as the control unit 320 of FIG. 3.

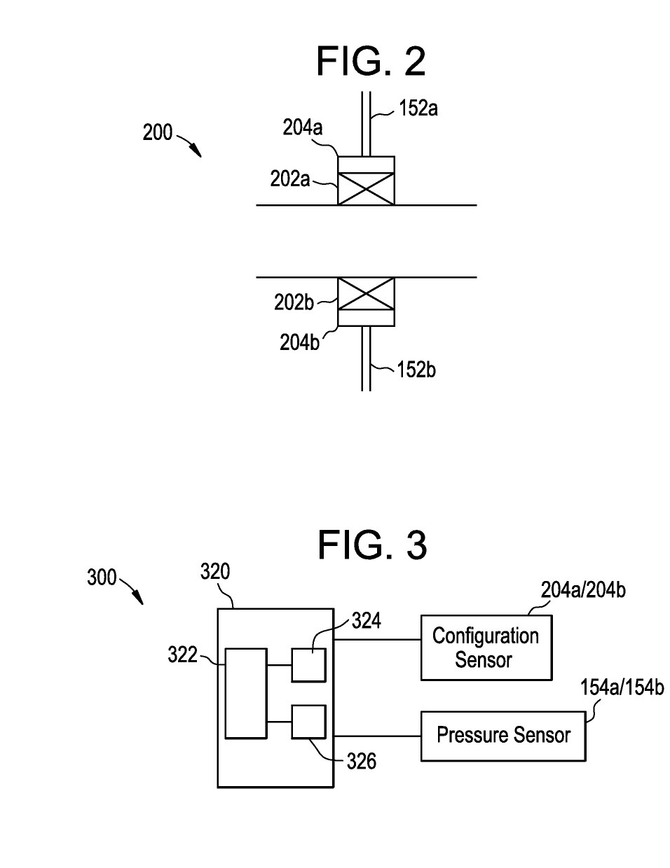

FIG. 2 shows a detailed illustration of an exemplary compressor bleed valve system 200 of the present disclosure. The compressor bleed valve system 200 generally includes two bleed valves 202a, and 202b which are coupled to the compressor section 110. Conduit 152a is coupled to bleed valve 202a and conduit 152b is coupled to bleed valve 202b. The bleed valves can be of any form that opens and closes to control airflow from the compressor into their associated air conduits, such as a bleed valve including a piston activated by a solenoid. The bleed valve 202a includes a configuration sensor 204a, and bleed valve 202b includes configuration sensor 204b. The configuration sensors can be, for example, limit switches. In an exemplary embodiment, a bleed valve that includes an activated piston, the configuration sensor can determine the configuration of the bleed valve by determining a position of the piston within the valve. The configuration sensors 204a and 204b provide signals indicative of the configurations of their associated bleed valve 202a and 202b to a monitoring device, such as the control unit 320 of FIG. 3 that monitors the bleed valve configurations. In various embodiments, the configuration sensors 204a and 204b are electrical devices and are generally affected by generator stresses and temperatures.

FIG. 3 shows a monitoring system 300 for monitoring the bleed valves 202a and 202b of the gas turbine generator in an exemplary embodiment of the present disclosure. In various aspects, monitoring includes but is not limited to determining a valve configuration, determining when the valve is in an incorrect configuration for a selected mode of operating the generator, determining when a configuration sensor is in error, or determining an action to take when a configuration error or configuration sensor error is detected. The exemplary monitoring system 300 includes a control unit 320 configured to control various operations of the gas turbine 100. The control unit 320 includes a memory 324, a set of programs 326 storing instructions therein for operating the generator 100 according to the methods described herein, and a processor 322 having access to the set of programs 346 and to the contents of the memory 324. The processor 322 is configured to run the various programs 346 for operating the gas turbine generator, as disclosed herein. In one aspect, the control unit 320 can set valve configurations at the generator according to a selected mode of operation, i.e., start-up, shut-down and steady-state. In particular, the control unit 320 can control the bleed valves 202a and 202b to be in either substantially opened or substantially closed configurations. The control unit 320 can also monitor various physical parameters, such as pressure measurements.

In an illustrative embodiment, the control unit 320 receives a signal from a configuration sensor 204a and a pressure measurement from a corresponding parameter sensor 154a. The signal from configuration sensor 204a provides a first indicator of the configuration of the compressor bleed valve 202a. The pressure measurement from the corresponding pressure sensor 154a provides a measurement of a compressor discharge pressure, which is affected by the configuration of compressor bleed valve 202a. The processor obtains a second indicator of the configuration of the compressor bleed valve 202a from the pressure measurement. In one embodiment, the processor compares the received pressure measurement to a selected pressure valve, wherein the results of the comparison indicate whether or not there is airflow in conduit 152a. Consequently, a second indicator indicating the configuration of bleed valve 202a is obtained. For example, but not limiting of, if the received pressure measurement is less than the selected pressure value, the processor determines that there is airflow in the conduit 152a and therefore obtains a second indicator indicating that bleed valve 202a is open. If the received pressure measure is greater than or equal to the selected pressure value, the processor determines that there is no airflow in conduit 152a and therefore obtains an indicator indicating that the bleed valve 202a is closed. The processor then compares the first indicator to the second indicator to monitor the bleed valve 202a. For a properly functioning compressor bleed valve 202a and/or configuration sensor 204a, the first indicator is the same as the second indicator. If the indicators differ from each other, then the processor can conclude that the either the bleed valve 202a or the configuration sensor 204a or both are not functioning properly. Also, when the indicators are different from each other, the processor can an appropriate action, such as tripping the generator (i.e., causing a shut-down of the generator). Although, the exemplary method of monitoring is discussed herein with reference to bleed valve 202a for illustrative purposes, it is understood that the exemplary monitoring methods apply equally to bleed valve 202b.

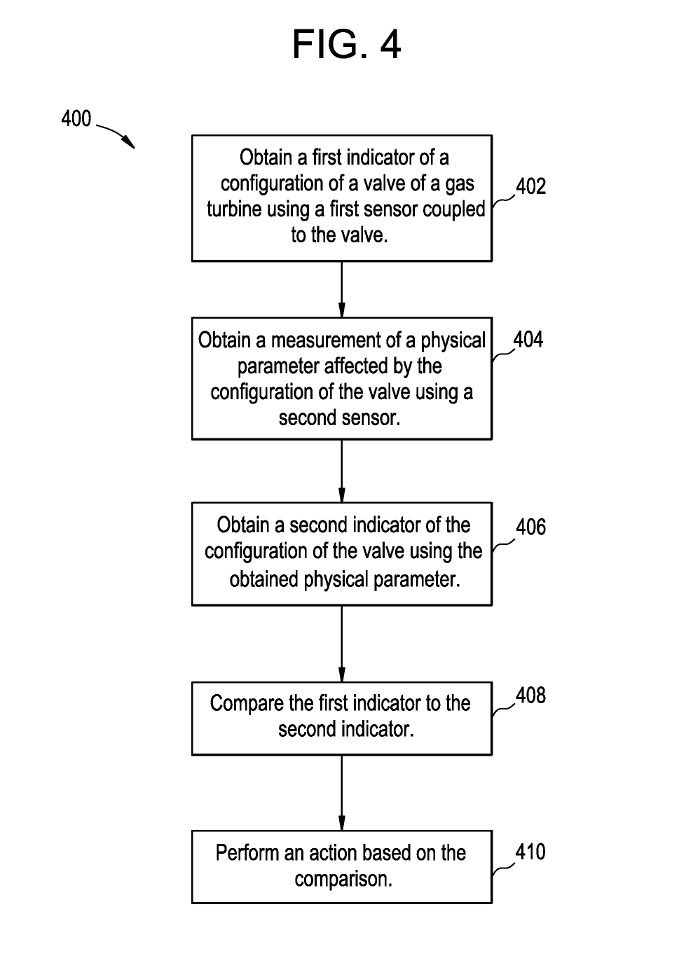

FIG. 4 shows a flow chart 400 of an exemplary method of the present disclosure for monitoring a valve. In Step 402, a first indicator of a configuration of a valve of a gas turbine is obtained, generally from a first sensor coupled to the valve. In Step 404, a physical parameter that is affected by the configuration of the valve is measured using a second sensor. In exemplary embodiments, the physical parameter is compressor discharge pressure. In Step 406, a second indicator of the configuration of the valve is obtained using the physical parameter obtained in Box 404. In Step 408, the first indicator is compared to the second indicator to monitor the valve. In Step 410, an action is performed based on a comparison of the first indicator and the second indicator. For example, when the first indicator differs from the second indicator, the processor can shut down the generator. Additionally, the processor can record the configuration sensor as being faulty and in need of replacement.

Therefore, in one aspect, the present disclosure provides a method of monitoring an operation of a valve of a gas turbine, including: obtaining a first indicator of a valve configuration using a configuration sensor coupled to the valve; measuring a physical parameter affected by the valve configuration; obtaining a second indicator of the valve configuration from the measured physical parameter; and comparing the first indicator and the second indicator to monitor the operation of the valve. In an exemplary embodiment, the valve is a compressor bleed valve coupled to a compressor of the gas turbine and the compressor bleed valve is coupled to an air passage between a compressor stage of the gas turbine and the turbine exhaust. In one embodiment, the configuration sensor determines a physical of a piston of the valve. The valve configuration is typically a substantially closed position blocking airflow or a substantially open position allowing airflow. Measuring the physical parameter typically includes measuring a compressor discharge pressure. In one embodiment, the gas turbine can be tripped when the first indicator differs from the second indicator. The comparison of the first indicator and the second indicator can also be used to monitor the configuration sensor.

In another aspect, the present disclosure provides an apparatus for monitoring an operation of a valve of a gas turbine, the apparatus including a first sensor configured to obtain a first indicator of a valve configuration of the valve; a second sensor configured to measure a physical parameter affected by the valve configuration; and a processor configured to: obtain a second indicator of the valve configuration from the measured physical parameter, and compare the first indicator to the second indicator to monitor the operation of the valve. In an exemplary embodiment, valve is a compressor bleed valve. The valve configuration of the compressor bleed valve is generally either a substantially closed position to block airflow or a substantially open position to allow airflow. In one embodiment, the first sensor indicates a position of a piston of the valve. The second sensor is configured to measure a compressor discharge pressure. In one embodiment, the processor is configured to trip the gas turbine when the first indicator differs from the second indicator. The processor may be further configured to compare the first indicator and the second indicator to monitor the first sensor.

In another aspect, the present disclosure provides a gas turbine that includes a compressor stage; a valve configured to control bleeding of air from the compressor stage; a first sensor configured to obtain a first indicator of a valve configuration of the valve; a second sensor configured to measure a physical parameter affected by the valve configuration; and a processor configured to: obtain a second indicator of the valve configuration from the measured physical parameter, and compare the first indicator to the second indicator to monitor an operation of the valve. In an exemplary embodiment, the valve is a compressor bleed valve. The second sensor is further configured to measure a compressor discharge pressure as the physical parameter. In one embodiment, the processor is configured to trip the gas turbine when the first indicator differs from the second indicator. Additionally, the processor can compare the first indicator to the second indicator to monitor the first sensor.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of monitoring an operation of a valve of a gas turbine, comprising:
obtaining a first indicator of a valve configuration using a configuration sensor coupled to the valve;
measuring a physical parameter affected by the valve configuration;
obtaining a second indicator of the valve configuration from the measured physical parameter; and
comparing the first indicator and the second indicator to monitor the operation of the valve.

2. The method of claim 1, wherein the valve is a compressor bleed valve coupled to a compressor of the gas turbine.

3. The method of claim 2, wherein the compressor bleed valve is coupled to an air passage between a compressor stage of the gas turbine and a turbine exhaust.

4. The method of claim 1, wherein the configuration sensor indicates a position of a piston of the valve.

5. The method of claim 1, wherein the valve configuration is one of: (i) a substantially closed position blocking airflow; and (ii) a substantially open position allowing airflow.

6. The method of claim 1, wherein measuring the physical parameter further comprises measuring a compressor discharge pressure.

7. The method of claim 1, further comprising tripping the gas turbine when the first indicator differs from the second indicator.

8. The method of claim 1 further comprising comparing the first indicator and the second indicator to monitor the configuration sensor.

9. An apparatus for monitoring an operation of a valve of a gas turbine, comprising:
a first sensor configured to obtain a first indicator of a valve configuration;
a second sensor configured to measure a physical parameter affected by the valve configuration; and
a processor configured to:
obtain a second indicator of the valve configuration from the measured physical parameter, and
compare the first indicator to the second indicator to monitor the operation of the valve.

10. The apparatus of claim 9, wherein the valve is a compressor bleed valve.

11. The apparatus of claim 10, wherein the valve configuration of the compressor bleed valve is one of (i) a substantially closed position to block airflow; and (ii) a substantially open position to allow airflow.

12. The apparatus of claim 9, wherein the first sensor further indicates a position of a piston of the valve.

13. The apparatus of claim 9, wherein the second sensor is further configured to measure a compressor discharge pressure.

14. The apparatus of claim 9, wherein the processor is further configured to trip the gas turbine when the first indicator differs from the second indicator.

15. The apparatus of claim 9 wherein the processor is further configured to compare the first indicator and the second indicator to monitor the first sensor.

16. A gas turbine, comprising:
a compressor stage;
a valve configured to control bleeding of air from the compressor stage;
a first sensor configured to obtain a first indicator of a valve configuration of the valve;
a second sensor configured to measure a physical parameter affected by the valve configuration; and
a processor configured to:
obtain a second indicator of the valve configuration from the measured physical parameter, and
compare the first indicator to the second indicator to monitor an operation of the valve.

17. The gas turbine of claim 16, wherein the valve further comprises a compressor bleed valve.

18. The gas turbine of claim 15, wherein the second sensor is further configured to measure a compressor discharge pressure.

19. The gas turbine of claim 15, wherein the processor is further configured to trip the gas turbine when the first indicator differs from the second indicator.

20. The gas turbine of claim 15, wherein the processor is further configured to compare the first indicator to the second indicator to monitor the first sensor.
